(19) United States
(12) Patent Application Publication
(10) Pub. No.: US 2026/0364965 A1
(43) Pub. Date: Nov. 19, 2026

(54) RECORDING APPARATUS

(71) Applicant: SEIKO EPSON CORPORATION, Tokyo (JP)

(72) Inventors: Kentaro NAKAMURA, SHIOJIRI-SHI (JP); Soshi OKAWA, SHIOJIRI-SHI (JP)

(21) Appl. No.: 19/679,869

(22) Filed: May 18, 2026

(30) Foreign Application Priority Data
May 19, 2025 (JP) 2025-083317

(51) Int. Cl. B41J 25/316; B41J 29/02; B41J 29/06

(52) U.S. Cl. CPC B41J 25/316; B41J 29/02; B41J 29/06

(57) ABSTRACT

A recording apparatus includes a first side plate and a second side plate that support a recorder, a first linkage member and a second linkage member that link the first side plate and the second side plate to each other, a first support that supports the first side plate, a second support that supports the second side plate, a third support that supports the first linkage member, and a fourth support that supports the second linkage member. The first support is provided for the first side plate at one location in a region occupied by the recorder in the second axis direction, and the second support is provided for the second side plate at one location in a region occupied by the recorder in the second axis direction.

The present application is based on, and claims priority from JP Application Serial Number 2025-083317, filed May 19, 2025, the disclosure of which is hereby incorporated by reference herein in its entirety.

### BACKGROUND

### 1. Technical Field

The present disclosure relates to a recording apparatus including an apparatus body and multiple supports that support the apparatus body.

### 2. Related Art

JP-A-2010-054542 describes an image forming apparatus that is an example of an instrument and is provided with three support members that are what are called rubber legs to prevent a change in the relative positional relationship between apparatuses such as an image creating apparatus and a transfer apparatus even at an uneven location where the image forming apparatus is installed. The reason why three support members are provided instead of four support members is that four or more support members do not settle supports in contact with the installation surface due to the unevenness of the installation surface or the accuracy of the assembly of the apparatus, resulting in poor stability.

In the image forming apparatus described in JP-A-2010-054542, the position of the center of gravity of the apparatus is located inside the triangle the vertices of which are the three support members, whereby the apparatus does not fall down and is maintained stable.

Furthermore, in the image forming apparatus described in JP-A-2010-054542, in view of the fact that the position of the center of gravity of the apparatus varies depending on: the situations of the usage of consumables such as the number of stored sheets and the amount of toner remaining in the image creating apparatus; and peripheral instruments attached to the apparatus, it has been proposed that, in consideration of the variation in the position of the center of gravity, two support members are disposed in the vicinity of corners of the bottom surface of the apparatus to increase the area of the triangle the vertices of which are the three support members, so that the stability of the apparatus against the variation in the center of gravity is improved.

JP-A-2010-054542 is an example of the related art.

When the image forming apparatus is supported by multiple support members, and when one of the multiple support members is raised due to a step or the like of the installation surface, there is a concern that a frame of the apparatus is deformed to adversely affect the quality of a formed image, and the image forming apparatus described in JP-A-2010-054542 does not take measures against such a problem.

### SUMMARY

A recording apparatus according to an aspect of the present disclosure includes: a recorder configured to perform recording on a medium; a first side plate having a surface intersecting with a first axis direction and configured to support the recorder; a second side plate having a surface intersecting with the first axis direction, disposed so as to be separate from the first side plate in the first axis direction, and configured to support the recorder; a first linkage member extending in the first axis direction and configured to link a bottom of the first side plate to a bottom of the second side plate; a second linkage member extending in the first axis direction, disposed so as to be separate from the first linkage member in a second axis direction intersecting with the first axis direction, and configured to link the bottom of the first side plate to the bottom of the second side plate; a first support that is a member being in contact with an installation surface at which the apparatus is installed and configured to support the first side plate; a second support that is a member being in contact with the installation surface and configured to support the second side plate; a third support that is a member being in contact with the installation surface and configured to support the first linkage member; and a fourth support that is a member being in contact with the installation surface and configured to support the second linkage member, the first support is provided for the first side plate at one location in a region occupied by the recorder in the second axis direction, and the second support is provided for the second side plate at one location in the region occupied by the recorder in the second axis direction.

### BRIEF DESCRIPTION OF THE DRAWINGS

FIG. 1 is an exterior perspective view of a printer.

FIG. 2 shows an entire medium conveyance path of the printer.

FIG. 3 shows a state in which a discharge tray is opened so that an adjustment dial is exposed.

FIG. 4 is a perspective view of a guide frame and a recording unit.

FIG. 5 is a plan view of the guide frame and the recording unit.

FIG. 6 is an enlarged view of a second guiding portion and surroundings thereof in FIG. 5.

FIG. 7 is an enlarged view of a first guiding portion and surroundings thereof in FIG. 5.

FIG. 8 is a cross-sectional perspective view of a first guided portion.

FIG. 9 is a cross-sectional perspective view of a second guided portion.

FIG. 10 is a cross-sectional view of the first guided portion.

FIG. 11 is a cross-sectional view of the second guided portion.

FIG. 12 is a perspective view of a worm wheel mechanism.

FIG. 13 is a perspective view of a rotation restricting member.

FIG. 14 is a cross-sectional perspective view of the worm wheel mechanism and shows a state in which the adjustment dial is present at a restriction imposed position.

FIG. 15 is a cross-sectional perspective view of the worm wheel mechanism and shows a state in which the adjustment dial is present at a restriction unlocked position.

FIG. 16 is a perspective view of the printer viewed from below.

FIG. 17 is a perspective view of a frame structure.

FIG. 18 is an exploded perspective view of the frame structure.

FIG. 19A is a diagrammatic view for illustrating a problem with a configuration of related art.

FIG. 19B is a diagrammatic view for illustrating the problem with the configuration of related art.

FIG. 20 is a plan view of the frame structure viewed from below.

FIG. 21 diagrammatically shows that the entire apparatus inclines.

FIG. 22 is a plan view of the frame structure viewed from below.

FIG. 23 is a plan view of the frame structure viewed from below.

### DESCRIPTION OF EMBODIMENTS

The present disclosure will be schematically described below.

A recording apparatus according to a first aspect includes: a recorder configured to perform recording on a medium; a first side plate having a surface intersecting with a first axis direction and configured to support the recorder; a second side plate having a surface intersecting with the first axis direction, disposed so as to be separate from the first side plate in the first axis direction, and configured to support the recorder; a first linkage member extending in the first axis direction and configured to link a bottom of the first side plate to a bottom of the second side plate; a second linkage member extending in the first axis direction, disposed so as to be separate from the first linkage member in a second axis direction intersecting with the first axis direction, and configured to link the bottom of the first side plate to the bottom of the second side plate; a first support that is a member being in contact with an installation surface at which the apparatus is installed and configured to support the first side plate; a second support that is a member being in contact with the installation surface and configured to support the second side plate; a third support that is a member being in contact with the installation surface and configured to support the first linkage member; and a fourth support that is a member being in contact with the installation surface and configured to support the second linkage member, the first support is provided for the first side plate at one location in a region occupied by the recorder in the second axis direction, and the second support is provided for the second side plate at one location in the region occupied by the recorder in the second axis direction.

For example, when the first side plate is provided with multiple supports in the second axis direction, and when one of the supports receives a push-up force from the apparatus installation surface, there is a concern that the first side plate is deformed or rotated relative to the second side plate with another support as a fulcrum. Such deformation or rotation of the first side plate may adversely affect recording quality. Note that the description has been made with reference to deformation or rotation of the first side plate, and that the same applies to deformation or rotation of the second side plate.

According to the present aspect, the first support is provided for the first side plate at one location in the region occupied by the recorder in the second axis direction, and the second support is provided for the second side plate at one location in the region occupied by the recorder in the second axis direction. Therefore, for example, when the first support receives a push-up force from the apparatus installation surface, the force is unlikely to cause deformation or rotation of the first side plate but is likely to cause inclination of the entire apparatus with the second support, which is provided for the second side plate, as a fulcrum. The same applies to a case where the second support receives a push-up force from the apparatus installation surface. That is, according to the arrangement of the supports in present aspect, deformation or rotation of the first side plate or the second side plate can be suppressed, and deterioration in recording quality can in turn be suppressed.

In addition, since the first support is provided for the first side plate at one location in the region occupied by the recorder in the second axis direction, and the second support is provided for the second side plate at one location in the region occupied by the recorder in the second axis direction, even if the first side plate or the second side plate is deformed or rotated to some extent, the influence of the deformation or rotation is small at the position of the recorder, so that deterioration in the recording quality can be suppressed.

A second aspect is an aspect according to the first aspect, in which the recorder includes an ink ejecting head configured to eject ink in a direction having a vertically downward component, the first support is provided for the first side plate at one location in a region occupied by a head surface of the ink ejecting head in the second axis direction, and the second support is provided for the second side plate at one location in the region occupied by the head surface in the second axis direction.

According to the present aspect, in the configuration in which the recorder includes the ink ejecting head configured to eject ink in the direction having a vertically downward component, the effects and advantages of the first aspect described above are provided. Furthermore, in particular, since the first support is provided for the first side plate at one location in the region occupied by the head surface of the ink ejecting head in the second axis direction, and the second support is provided for the second side plate at one location in the region occupied by the head surface in the second axis direction, even if the first side plate or the second side plate is deformed or rotated to some extent, the influence of the deformation or rotation is small at the position of the head surface, so that deterioration in the recording quality can be effectively suppressed.

A third aspect is an aspect according to the first or second aspect, in which a position of a center of gravity of the apparatus overlaps with the recorder in a bottom view of the apparatus.

According to the present aspect, since the position of the center of gravity of the apparatus overlaps with the recorder in the bottom view of the apparatus, the first support and the position of the center of gravity are close to each other in the second axis direction, so that deformation of the first side plate is suppressed. Similarly, the second support and the position of the center of gravity are close to each other in the second axis direction, so that deformation of the second side plate is suppressed. The deterioration in the recording quality can thus be further suppressed.

A fourth aspect is an aspect according to the third aspect, in which the position of the center of gravity is within a region occupied by the first support and the second support in the second axis direction.

According to the present aspect, since the position of the center of gravity is within the region occupied by the first support and the second support in the second axis direction, the posture of the apparatus is likely to be stabilized in the second axis direction, and the deformation of the first side plate and the second side plate is suppressed, so that the deterioration in the recording quality can be suppressed.

A fifth aspect is an aspect according to the third aspect, in which the third support and the fourth support are separate from the first side plate and the second side plate by at least 1/4 of a distance between the first side plate and the second side plate in the first axis direction.

According to the present aspect, since the third support and the fourth support are separate from the first side plate and the second side plate by at least 1/4 of the distance between the first side plate and the second side plate in the first axis direction, when the third support or the fourth support receives a push-up force from the apparatus installation surface, the influence of the push-up force on the deformation of the first side plate or the second side plate can be reduced, so that the deterioration in the recording quality can be suppressed.

Note that the present aspect is not necessarily an aspect according to the third aspect described above, and may be an aspect according to any of the first, second, and fourth aspects described above.

A sixth aspect is an aspect according to the fifth aspect, in which the third support and the fourth support are provided at a middle position between the first side plate and the second side plate in the first axis direction.

According to the present aspect, since the third support and the fourth support are provided at the middle position between the first side plate and the second side plate in the first axis direction, the third support and the fourth support are provided at positions farthest from the first side plate and the second side plate. Therefore, when the third support or the fourth support receives a push-up force from the apparatus installation surface, the influence of the push-up force on the deformation of the first side plate or the second side plate can be effectively reduced, so that the deterioration in the recording quality can be suppressed.

A seventh aspect is an aspect according to the sixth aspect, in which the position of the center of gravity is within a region occupied by the third support and the fourth support in the first axis direction.

According to the present aspect, since the position of the center of gravity is within the region occupied by the third support and the fourth support in the first axis direction, the posture of the apparatus is likely to be stabilized in the first axis direction, and the deformation of the first linkage member and the second linkage member is suppressed, so that the deterioration in the recording quality can be suppressed.

An eighth aspect is an aspect according to the first aspect, in which the first support and the second support are each configured with one leg.

According to the present aspect, since the first support and the second support are each configured with one leg, deformation of the first side plate and the second side plate can be suppressed as compared with a case where the first support and the second support are each configured with multiple legs.

Note that the present aspect is not necessarily an aspect according to the first aspect described above, and may instead be an aspect according to any of the second to seventh aspects described above.

A ninth aspect is an aspect according to the first aspect, in which a position of a center of gravity of the apparatus moves as an optional apparatus is attached to and detached from the recording apparatus or as a movable portion in the recording apparatus moves, and the position of the center of gravity in a bottom view of the apparatus is located within a region vertices of which coincide with the first support, the second support, the third support, and the fourth support before and after the movement.

In the configuration in which the position of the center of gravity of the apparatus moves as an optional apparatus is attached to and detached from the recording apparatus or as a movable portion in the recording apparatus moves, when the position of the center of gravity in a bottom view of the apparatus is off the region the vertices of which coincide with the first support, the second support, the third support, and the fourth support, the posture of the apparatus is likely to be unstable.

However, the present aspect, in which the position of the center of gravity of the apparatus in the bottom view of the apparatus is located within the region the vertices of which coincide with the first support, the second support, the third support, and the fourth support before and after the movement, can prevent the posture of the apparatus from becoming unstable due to the movement of the position of the center of gravity.

Note that the present aspect is not necessarily an aspect according to the first aspect described above, and may instead be an aspect according to any of the second to eighth aspects described above.

A tenth aspect is an aspect according to the first aspect, and the recording apparatus further includes: a facing portion that is a member facing the recorder, extending along the first axis direction, and supported by the first side plate and the second side plate; and a guide frame configured to guide a recording unit including the recorder along a third axis direction being a direction in which a distance between the recorder and the facing portion changes, the guide frame fixed to the first side plate and the second side plate, the guide frame includes a first guiding portion configured to guide the recording unit along the third axis direction, and a second guiding portion located at a position separate from the first guiding portion in the first axis direction and configured to guide the recording unit along the third axis direction, the recording unit includes a first guided portion guided by the first guiding portion, and a second guided portion guided by the second guiding portion, the first guided portion is configured with multiple first guided portions provided in the third axis direction, and the second guided portion is configured with one second guided portion provided in the third axis direction.

It is assumed below that a side plate close to the first guiding portion is the first side plate, and that a side plate close to the second guiding portion is the second side plate. In this case, when the first side plate is deformed or rotated, the first guiding portion inclines. When the first guiding portion inclines, the recording unit also tends to incline.

The recording unit including the recorder includes the first guided portions guided by the first guiding portion and the second guided portion guided by the second guiding portion. Multiple first guided portions are provided for the first guiding portion, and one second guided portion is provided for the second guiding portion. The inclination of the first guiding portion is therefore followed by inclination of the recording unit. That is, since only one second guided portion is provided for the second guiding portion, the second guiding portion is unlikely to restrict rotation of the recording unit. The inclination of the first guiding portion is therefore followed by inclination of the recording unit.

However, the facing portion is supported by the first side plate and the second side plate. Therefore, when the first side plate is deformed or rotated, the facing portion inclines at a position close to the first side plate, but does not incline at a position close to the second side plate because the facing portion is restricted by the second side plate.

As described above, in the configuration in which multiple first guided portions are provided for the first guiding portion and one second guided portion is provided for the second guiding portion, the recorder and the facing portion incline in the same manner at a position close to the first side plate, but the recorder inclines with respect to the facing portion at a position close to the second side plate because only the recorder inclines at the position close to the second side plate, so that there is a concern that the recording quality deteriorates.

However, the first aspect described above, in which the deformation or rotation of the first side plate is suppressed, can suppress the inclination of the recorder with respect to the facing portion at the position close to the second side plate, so that the deterioration in the recording quality can be suppressed.

In the above description, it is assumed that the side plate close to the first guiding portion is the first side plate, and that the side plate close to the second guiding portion is the second side plate, and the same holds true for a case where the first side plate and the second side plate are swapped.

Note that the present aspect is not necessarily an aspect according to the first aspect described above, and may instead be an aspect according to any of the second to ninth aspects described above.

An eleventh aspect is an aspect according to the tenth aspect, in which the second guided portion also serves as a rotation mechanism configured to rotate the recording unit with the first guiding portion as a fulcrum when viewed in the third axis direction.

The gap between the recorder and the facing portion is hereinafter referred to as a platen gap for convenience. According to the present aspect, in which the second guided portion includes the rotation mechanism configured to rotate the recording unit with the first guiding portion as a fulcrum when viewed in the third axis direction, the inclination of the recorder with respect to the medium conveyance direction can be adjusted.

According to the present aspect, since the second guided portion also serves as the rotation mechanism configured to rotate the recording unit with the first guiding portion as a fulcrum when viewed in the third axis direction, a portion of a mechanism that allows the recording unit to move in a direction in which the platen gap is adjusted is used as a mechanism that adjusts the posture of the recording unit, so that increases in cost and size of the apparatus can be suppressed.

The present disclosure will be specifically described below.

An inkjet printer 1 will be described below as an example of a recording apparatus that performs recording on a medium. The inkjet printer 1 will be hereinafter referred simply to as a printer 1.

Note that an X-Y-Z coordinate system shown in the drawings is an orthogonal coordinate system in which a side at which an arrow points corresponds to a positive (+) direction and the direction opposite the positive (+) direction is a negative (−) direction. The X-axis direction is an apparatus width direction and is the width direction of a medium on which recording is performed. When viewed from an operator of the printer 1, the +X direction corresponds to the left side, and the −X direction corresponds to the right side. In the following description, the X-axis direction is referred to as a medium width direction or simply as a width direction in some cases.

The Y-axis direction is an apparatus depth direction and is the direction along a medium conveyance direction during recording. The +Y direction is the direction from an apparatus rear surface toward an apparatus front surface, and the −Y direction is the direction from the apparatus front surface toward the apparatus rear surface. In the present embodiment, out of the side surfaces that constitute the circumference of the printer 1, the +Y-side side surface is the apparatus front surface, and the −Y-side side surface is the apparatus rear surface.

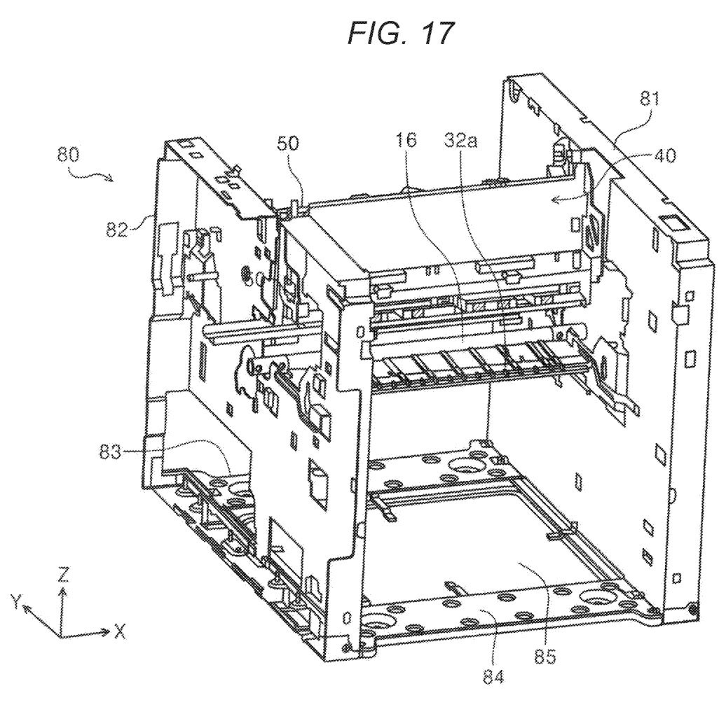

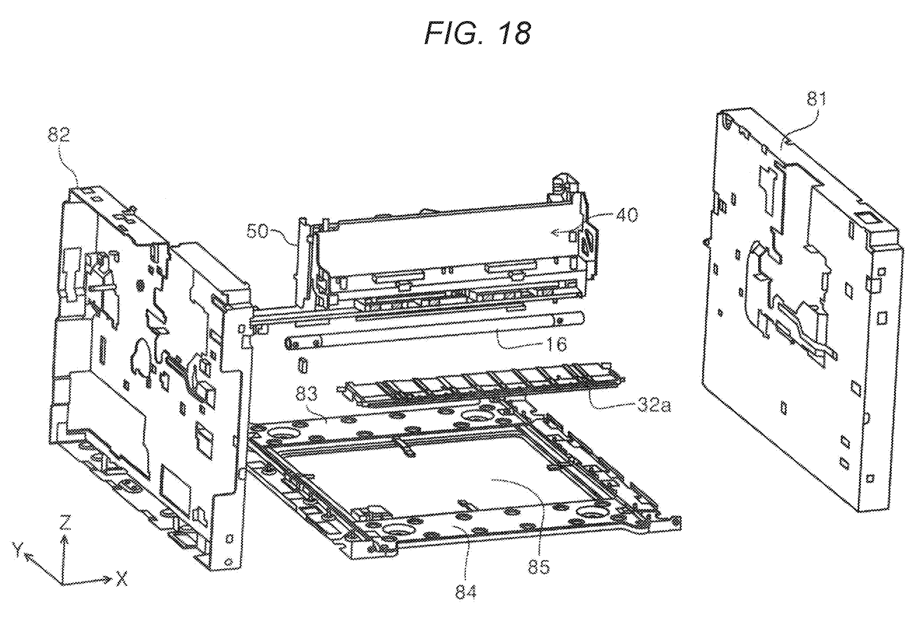

Note that the X-axis direction is an example of a first axis direction that intersects with the surfaces of a first side plate 81 and a second side plate 82 (see FIGS. 17 and 18), which will be described later, and that the Y-axis direction is an example of a second axis direction that intersects with the first axis direction.

The Z-axis direction is a direction along the vertical direction and is an apparatus height direction. The +Z direction is the vertically upward direction, and the −Z direction is the vertically downward direction. The Z-axis direction is an example of a third axis direction including a direction in which a platen gap, which will be described later, changes.

Note in the following description that a direction in which the medium is conveyed may be referred to as "downstream", and that the direction opposite the medium conveyance direction may be referred as "upstream".

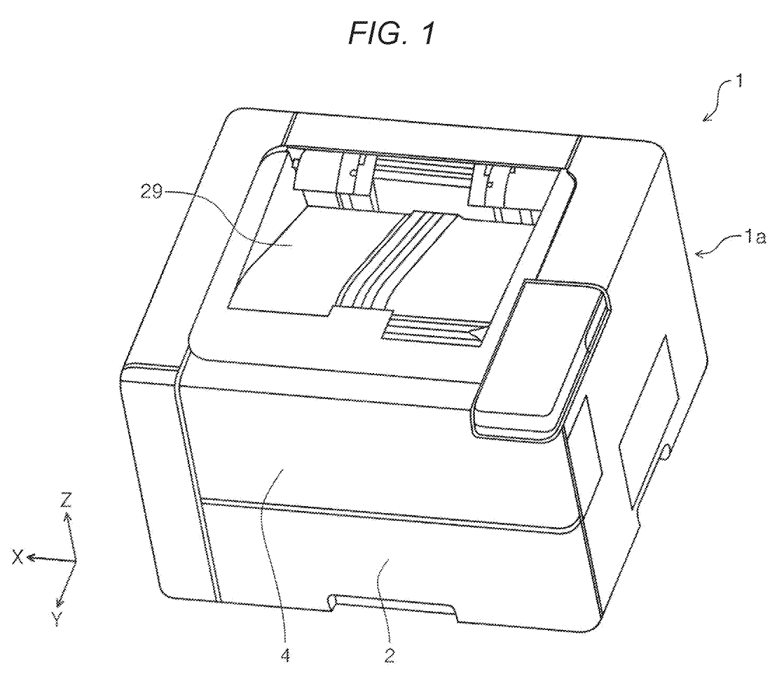

In FIG. 1, the printer 1 includes a medium storage cassette 2 in a lower portion of an apparatus body 1a. A discharge tray 29 is provided in an upper portion of the apparatus body 1a. Reference character 4 represents an openable/closeable member provided at the apparatus front surface. The openable/closeable member 4 can be tilted in the +Y direction with a lower end thereof as a fulcrum, so that a medium stacker 12, which will be described later, is exposed.

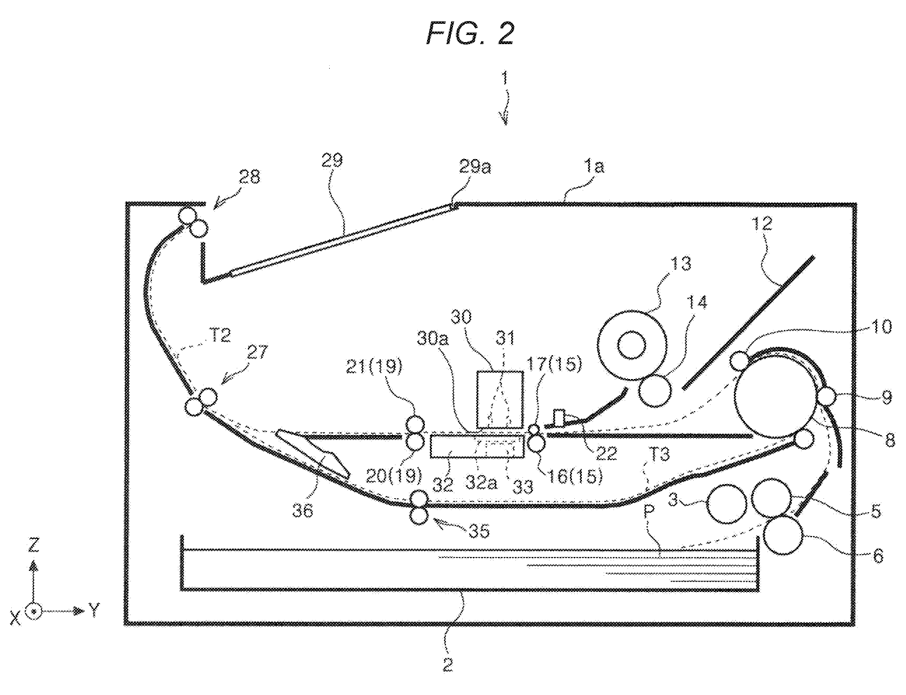

A medium conveyance path of the printer 1 will be described below with reference to FIG. 2. In FIG. 2, the medium conveyance path is indicated by a broken line.

Reference character P represents media stored in the medium storage cassette 2. An example of the media may be recording sheets. The medium storage cassette 2 is provided so as to be detachable from the apparatus front side.

A pickup roller 3 driven by a motor that is not shown is disposed above the medium storage cassette 2. The pickup roller 3 is capable of advancing to and retracting from the media stored in the medium storage cassette 2, and rotates while being in contact with the media stored in the medium storage cassette 2 to feed the media from the medium storage cassette 2 in the +Y direction.

A feed roller 5, which is driven by a motor that is not shown, and a separation roller 6, to which rotational torque is applied by a torque limiter that is not shown, are provided downstream of the medium storage cassette 2. The medium fed from the medium storage cassette 2 is nipped and separated from the rest of the media by the feed roller 5 and the separation roller 6, and is further fed downstream.

A flipping roller 8 driven by a motor that is not shown is provided downstream of the feed roller 5 and the separation roller 6. A first nip roller 9 and a second nip roller 10 are provided around the flipping roller 8. The medium is nipped by the flipping roller 8 and the first nip roller 9, further nipped by the flipping roller 8 and the second nip roller 10, and conveyed. The conveyance direction of the medium is reversed by the flipping roller 8 from the +Y direction to the −Y direction, and the medium is conveyed downstream.

The printer 1 further has a medium feed path starting from the medium stacker 12 in addition to a medium feed path starting from the medium storage cassette 2. The medium stacker 12 supports the medium in an inclining posture, and the supported medium is conveyed to a first conveyance roller pair 15 by a feed roller 13 driven by a motor that is not shown. Reference character 14 represents a separation roller to which rotational torque is applied by a torque limiter that is not shown.

The first conveyance roller pair 15, which includes a driving roller 16, which is driven by a motor that is not shown, and a driven roller 17, which is rotatable in conjunction with the driving roller 16, is disposed downstream of the flipping roller 8. The driven roller 17 is pressed against the driving roller 16 by a pressing member that is not shown.

A line head 30 constitutes a recorder that performs recording on the medium. The line head 30 is an example of an ink ejecting head that ejects ink, which is an example of a liquid, onto the medium to perform recording. The line head 30 is a liquid ejecting head in which multiple nozzles 31, via which the ink is ejected, are arranged to cover the entire medium in the medium width direction. The line head 30 is configured as a liquid ejecting head elongated in the medium width direction, and capable of performing recording on the entire medium width region without moving in the medium width direction.

Reference character 30a represents a head surface facing the medium. The head surface 30a may also be referred to as a liquid ejection surface or a nozzle surface. The head surface 30a is parallel to the medium conveying direction, that is, the Y-axis direction, at a position where the medium faces the line head 30. The head surface 30a is further parallel to the X-Y plane.

The printer 1 includes an ink storage that is not shown, and the ink to be ejected from the line head 30 is supplied from an ink storage to the line head 30 via an ink tube that is not shown.

Note that the line head 30 may be replaced with a recording head that performs recording on the medium while moving along the medium width direction. The recorder is not necessarily configured with a recording head that ejects ink to perform recording on the medium, and may instead be configured with a recording head using a dot-impact method or any other method.

A head facing portion 32 is provided at a position where the head facing portion 32 faces the head surface 30a of the line head 30. The head facing portion may also be referred to as a platen. The head facing portion 32 according to the present embodiment includes an openable and closable shutter 32a (see FIG. 18), and the head facing portion 32 supports the medium in a state in which the shutter 32a is closed. The gap between the head facing portion 32 and the head surface 30a is hereinafter referred to as a platen gap. The line head 30 is provided in a movable manner in a direction in which the line head 30 advances to and retracts from the head facing portion 32, that is, a direction in which the platen gap is adjusted. In the present embodiment, the direction in which the platen gap is adjusted is parallel to the Z-axis direction. In the following description, the line head 30 moving in the +Z-axis direction may be referred to as "upward" and the line head 30 moving in the −Z direction may be referred to as "downward".

A cap portion 33 is provided below the shutter 32a. When the shutter 32a opens, the cap portion 33 and the head surface 30a can face each other. The line head 30 is provided to be capable of moving upward and downward with the aid of power from a motor that is not shown. The cap portion 33 can cover the head surface 30a when the line head 30 moves downward in the state in which the shutter 32a is open.

A second conveyance roller pair 19 including a driving roller 20, which is driven by a motor that is not shown, and a driven roller 21, which is rotatable in conjunction with the driving roller 20, is provided downstream of the line head 30. The medium on which recording has been performed is sent downstream by the second conveyance roller pair 19.

The driven roller 21 is pressed against the driving roller 20 by a pressing member that is not shown.

A third conveyance roller pair 27 is provided downstream of the second conveyance roller pair 19, and a discharge roller pair 28 is further provided downstream of the third conveyance roller pair 27. The portion between the third conveyance roller pair 27 and the discharge roller pair 28 is configured as a face-down discharge path T2, and the medium on which recording has been performed is discharged to the discharge tray 29 by the discharge roller pair 28 in a state in which the most recently recorded surface is faced down.

The discharge tray 29 is provided to be openable and closable by rotating around a turning shaft 29a with respect to the apparatus body 1a of the printer 1. The axial center line of the turning shaft 29a is parallel to the X-axis. A user can access the interior of the printer 1 by opening the discharge tray 29.

Note that the discharge tray 29 may be detachably provided instead of being provided in an openable and closable manner.

A flap 36 is provided between the second conveyance roller pair 19 and the third conveyance roller pair 27. The third conveyance roller pair 27 and the discharge roller pair 28 can be rotated in the opposite direction, and the medium can be fed to a flipping path T3 by rotating the third conveyance roller pair 27 and the discharge roller pair 28 in the opposite direction in a state in which the trailing end of the medium is located between the flap 36 and the third conveyance roller pair 27.

A fourth conveyance roller pair 35 is provided in the flipping path T3, and the medium fed to the flipping path T3 is sent to the flipping roller 8. Providing the thus configured flipping path T3 allows recording to be performed on opposite surfaces of the medium.

A mechanism that moves upward and downward the line head 30 and a mechanism that rotates the line head 30 viewed in the Z-axis direction will next be described.

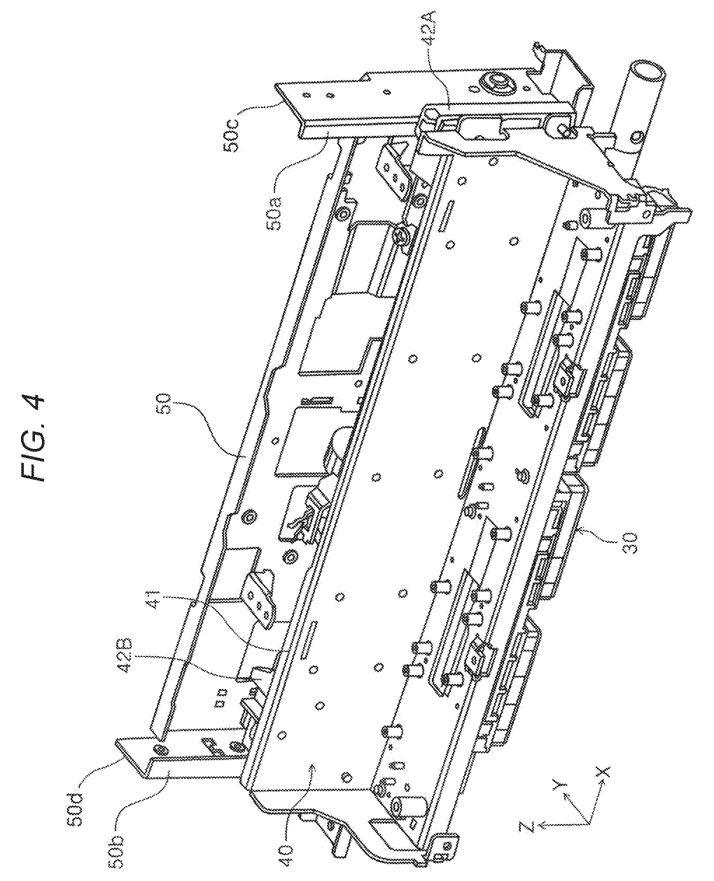

In FIG. 4, reference character 50 represents a guide frame that constitutes a base of the apparatus body 1a. The guide frame 50 is formed by bending a metal plate, includes a first guiding portion 50a and a first side frame portion 50c at a +X-side end portion, and includes a second guiding portion 50b and a second side frame portion 50d at a −X-side end portion. The first guiding portion 50a and the second guiding portion 50b are plate-shaped portions that form surfaces parallel to the X-Z plane and extend along the Z-axis direction. The first side frame portion 50c and the second side frame portion 50d are plate-shaped portions that form surfaces parallel to the Y-Z plane and extend along the Z-axis direction. The second guiding portion 50b is located at a position separate from the first guiding portion 50a in the X-axis direction, that is, the width direction.

The first guiding portion 50a is a −Y-side end portion of the first side frame portion 50c that is bent in the −X direction. The second guiding portion 50b is a −Y-side end portion of the second side frame portion 50d that is bent in the +X direction.

Reference character 40 represents a recording unit including the line head 30. The recording unit 40 is configured with a unit frame 41 including the line head 30. The unit frame 41 is formed by bending a metal plate as the guide frame 50 is.

Out of the surfaces of the unit frame 41, the +Y-side surface is provided with a rack member 42A at a +X-side end portion and a rack member 42B at a −X-side end portion.

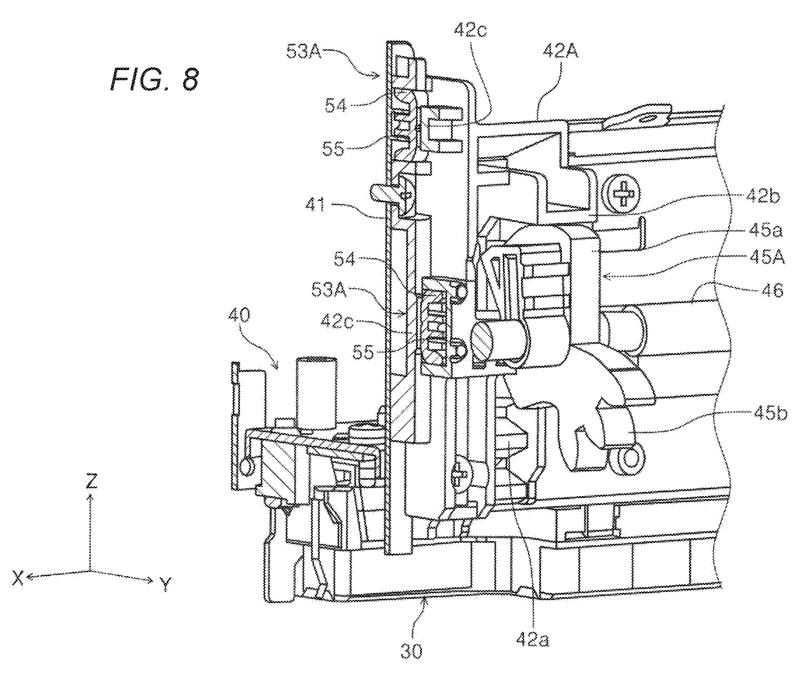

The rack member 42A includes a rack 42a formed along the Z-axis direction, as shown in FIG. 8. The rack member 42A further includes a supported portion 42b formed so as to protrude in the +Y direction.

A shaft 46 extending in the X-axis direction is provided at a position shifted from the guide frame 50 in the +Y direction. The shaft 46 is driven by a motor that is not shown. A rotary member 45A is provided at a −X-side end portion of the shaft 46, as shown in FIG. 8. The rotary member 45A includes a cam 45a and a pinion 45b. The cam 45a supports the supported portion 42b of the rack member 42A. The outer circumference of the cam 45a is so formed that the diameter thereof changes in the circumferential direction, so that when the rotary member 45A rotates, a Z-axis-direction position of the supported portion 42b changes, resulting in a change in the platen gap.

For example, let a first recording position be the position of the line head 30 in recording performed on a plain sheet, and the line head 30 is positioned at a second recording position shifted upward from the first recording position in recording performed on a special sheet thicker than the plain sheet. The cam 45a thus specifies the position where the line head 30 performs recording.

The region over which the line head 30 is moved has a jam processing position that is a position where the line head 30 is moved to the uppermost point. The pinion 45b engages with the rack 42a, and the pinion 45b and the rack 42a configure a rack-and-pinion mechanism. When the cam 45a separates from the supported portion 42b in response to the rotation of the rotary member 45A, the cam 45a moves to a region where the pinion 45b engages with the rack 42a, so that the line head 30 can move upward to the jam processing position. When the line head 30 moves upward to the jam processing position, the platen gap is maximized. When a jam occurs, the maximized platen gap allows removal of a jammed medium. The jam processing can be performed by opening the discharge tray 29 described above.

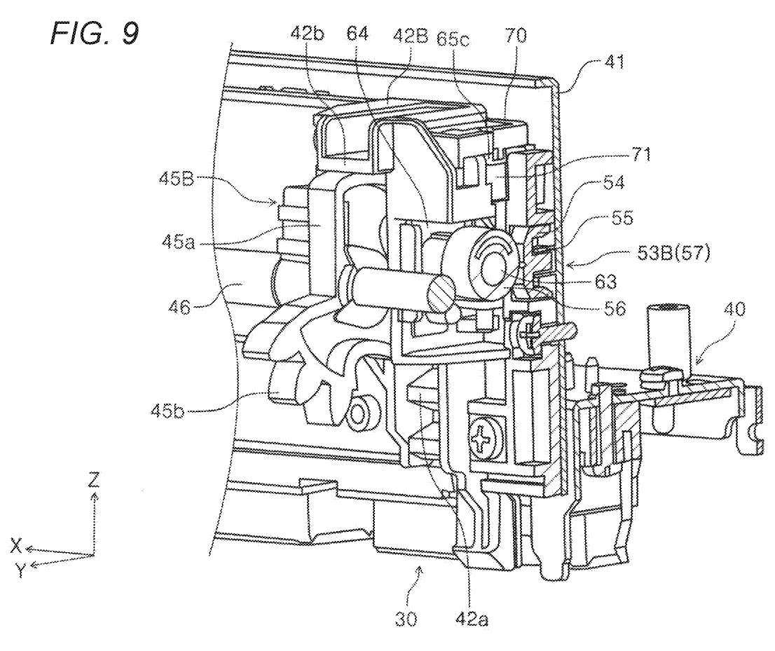

A rotary member 45B, which is configured in the same manner as the rotary member 45A, is also provided at a −X-side end portion of the shaft 46, as shown in FIG. 9. The rotary member 45B includes a cam 45a and a pinion 45b, as the rotary member 45A. The rack member 42B includes a supported portion 42b and a rack 42a, as the rack member 42A.

As described above, the recording unit 40 is supported by the cams 45a or the pinions 45b at opposite ends in the X-axis direction.

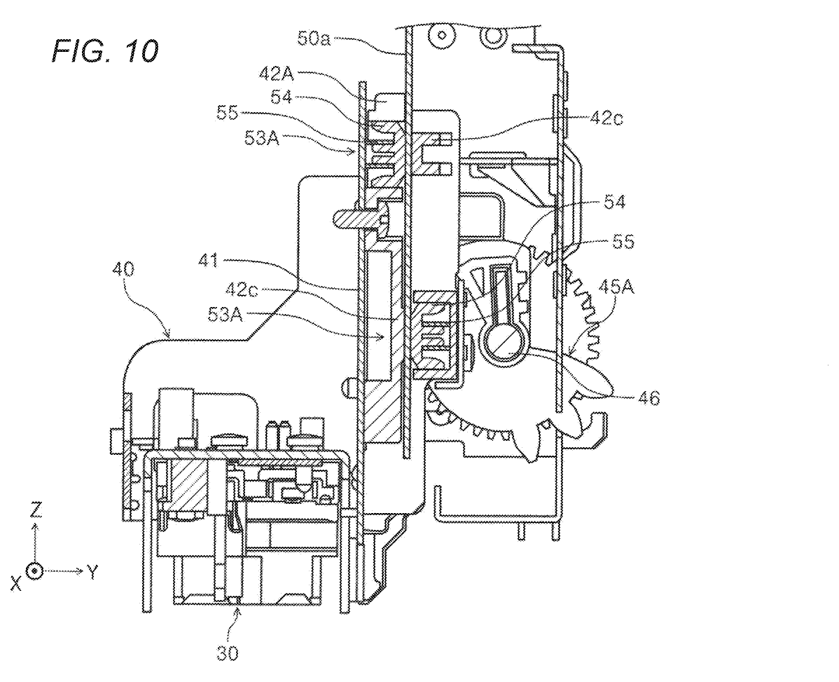

The recording unit 40 includes first guided portions 53A, as shown in FIGS. 8 and 10. The first guided portions 53A are each a portion guided by the first guiding portion 50a in the Z-axis direction. Note that FIG. 8 does not show the first guiding portion 50a.

Two first guided portions 53A are provided so as to be separate from each other along the Z-axis, and are each configured to sandwich the first guiding portion 50a in the Y-axis direction.

In more detail, each of the first guided portions 53A, specifically, a slide portion 42c formed at the rack member 42A and a slider 54 provided at the rack member 42A are configured to sandwich the first guiding portion 50a.

In the rack member 42A, the slider 54 is held in a displaceable manner in the direction in which the slider 54 moves toward and away from the first guiding portion 50a, that is, in the Y-axis direction, and is pressed against the first guiding portion 50a by a coil spring 55, which is an example of a pressing member. In the first guided portion 53A provided at a farthest position in the +Z direction, the slider 54 is provided at a position shifted from the first guiding portion 50a in the −Y direction, and the slide portion 42c is provided at a position shifted from the first guiding portion 50a in the +Y direction. In the first guided portion 53A provided at a farthest position in the −Z direction, the slider 54 is provided at a position shifted from the first guiding portion 50a in the +Y direction, and the slide portion 42c is provided at a position shifted from the first guiding portion 50a in the −Y direction.

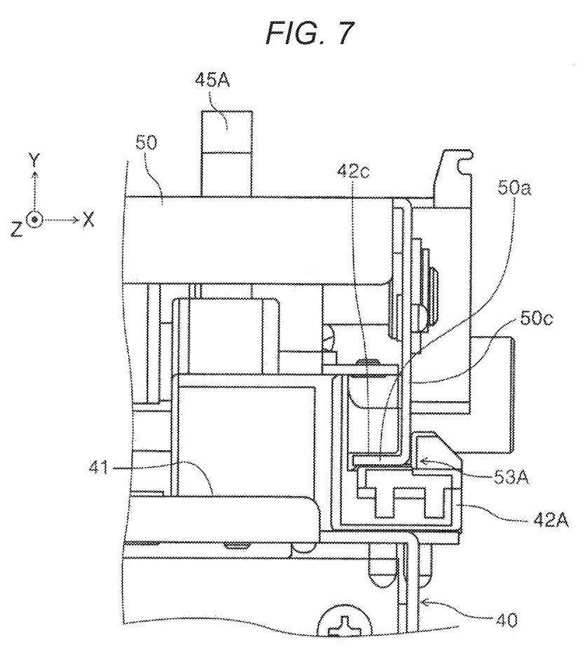

Note that the rack member 42A is shaped to sandwich the first side frame portion 50c in the X-axis direction, as shown in FIG. 7. The position of the recording unit 40 in the X-axis direction is thus restricted.

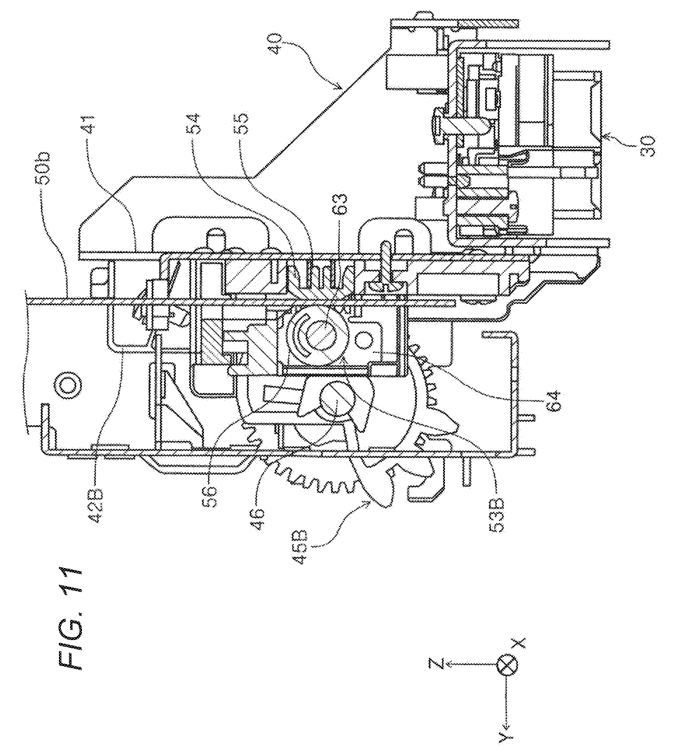

The recording unit 40 includes a second guided portion 53B, as shown in FIGS. 9 and 11. The second guided portion 53B is a portion guided by the second guiding portion 50b in the Z-axis direction. Note that FIG. 9 does not show the second guiding portion 50b.

One second guided portion 53B is provided in the Z-axis direction, and is configured to sandwich the second guiding portion 50b in the Y-axis direction.

In more detail, the second guided portion 53B, specifically, a slider 54 and an eccentric cam 56 provided at the rack member 42B are configured to sandwich the second guiding portion 50b. The slider 54 is an example of a first contact portion and, the eccentric cam 56 is an example of a second contact portion.

In the rack member 42B, the slider 54 is held in a displaceable manner in the direction in which the slider 54 moves toward and away from the second guiding portion 50b, that is, in the Y-axis direction, and is pressed against the second guiding portion 50b by a coil spring 55, which is an example of a pressing member. Note that the slider 54 is provided at a position shifted from the second guiding portion 50b in the −Y direction. The eccentric cam 56 is provided at a position shifted from the second guiding portion 50b in the +Y direction.

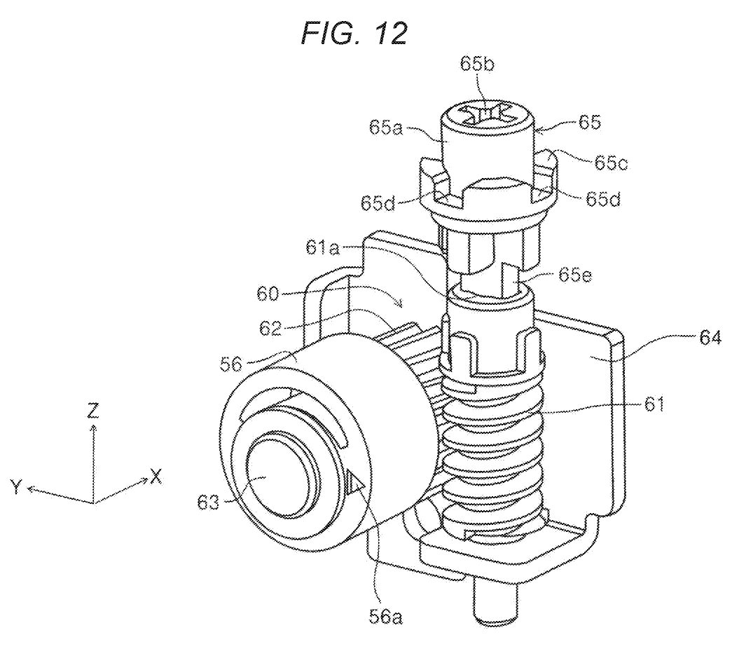

A worm gear mechanism 60 shown in FIG. 12 is provided at the rack member 42B. The worm gear mechanism 60 includes a worm 61 and a worm wheel 62 at a support frame 64. The support frame 64 is provided at the rack member 42B.

The eccentric cam 56 rotates along with the worm wheel 62 as a unit around a support shaft 63 provided in the support frame 64. The axial center line of the support shaft 63 is parallel to the X-axis.

The worm 61 is provided in a rotatable manner at the support frame 64. The center line of the rotary shaft of the worm 61 is parallel to the Z-axis. The worm 61 engages with the worm wheel 62, and the rotation of the worm 61 causes the worm wheel 62 to rotate, that is, the eccentric cam 56 to rotate.

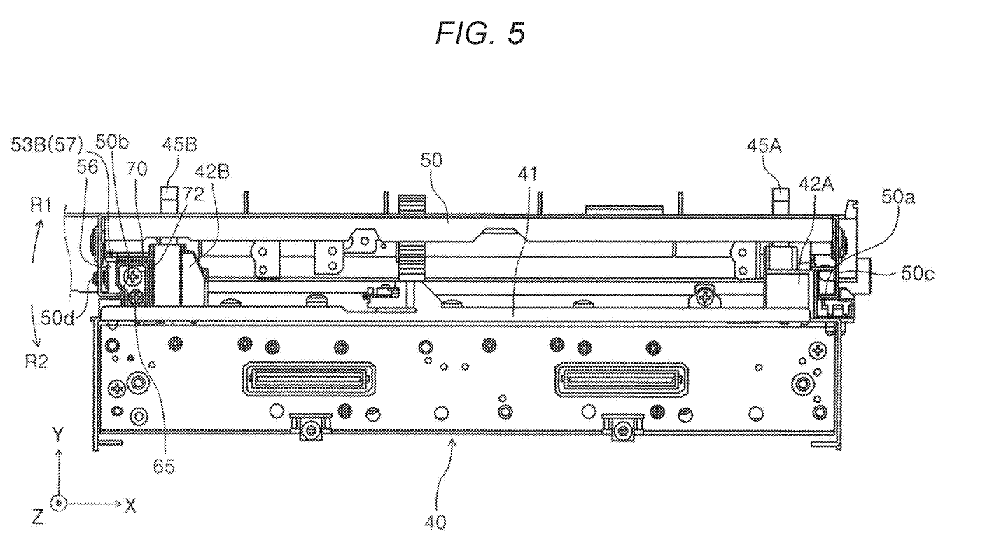

When the eccentric cam 56 rotates, the recording unit 40 rotates with the first guiding portion 50a as a fulcrum when viewed along the Z-axis, as indicated by arrows R1 and R2 in FIG. 5. The posture, that is, the inclination of the line head 30 with respect to the medium conveyance direction can thus be adjusted, so that the recording quality can be adjusted.

As described above, the eccentric cam 56 constitutes a rotation mechanism 57, which rotates the recording unit 40 with the first guiding portion 50a as a fulcrum when viewed along the Z-axis. That is, the second guided portion 53B also serves as the rotation mechanism 57, which rotates the recording unit 40 with the first guiding portion 50a as a fulcrum when viewed along the Z-axis.

To allow the aforementioned rotation of the recording unit 40, play is created between the rack member 42B and the first side frame portion 50c in a portion where the rack member 42B sandwiches the first side frame portion 50c (refer to FIG. 7).

A fitting hole 61a is formed at an upper end portion of the worm 61, as shown in FIG. 12. A fitting portion 65e, which is a protrusion formed at a lower end portion of an adjustment dial 65, fits into the fitting hole 61a. Rotating the adjustment dial 65 therefore rotates the worm 61 and in turn rotates the eccentric cam 56. Note that the fitting portion 65e is displaceable in the Z-axis direction with respect to the fitting hole 61a.

An upper portion of the adjustment dial 65 firms a cylindrical portion 65a. The cylindrical portion 65a has a screwdriver fitting hole 65b having a screwdriver fitting shape to which a Phillips screwdriver is fitted.

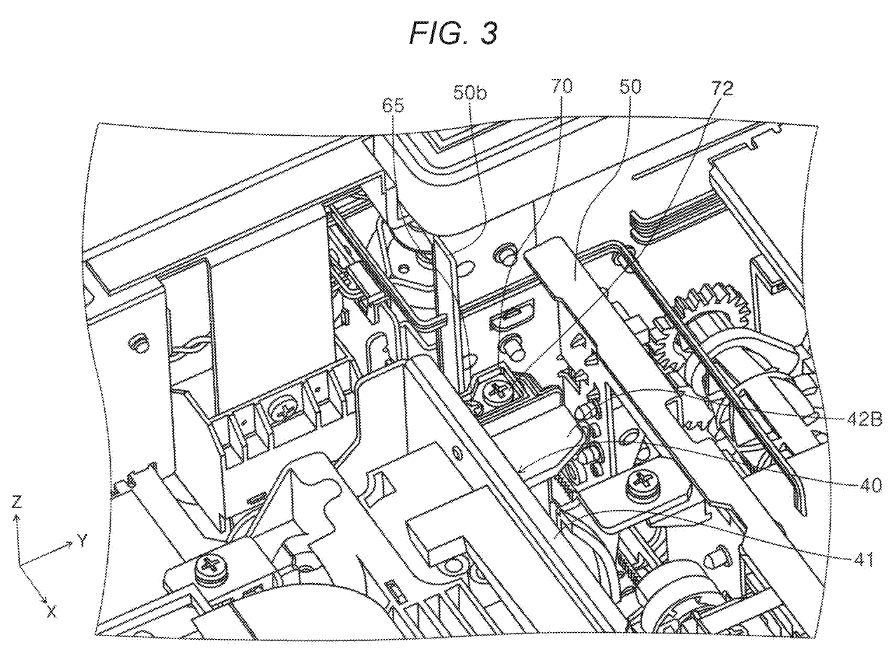

The adjustment dial 65 is exposed as shown in FIG. 3 when the discharge tray 29 (see FIGS. 1 and 2) is opened. That is, opening the discharge tray 29 allows rotation of the adjustment dial 65, so that the recording unit 40 can be rotated.

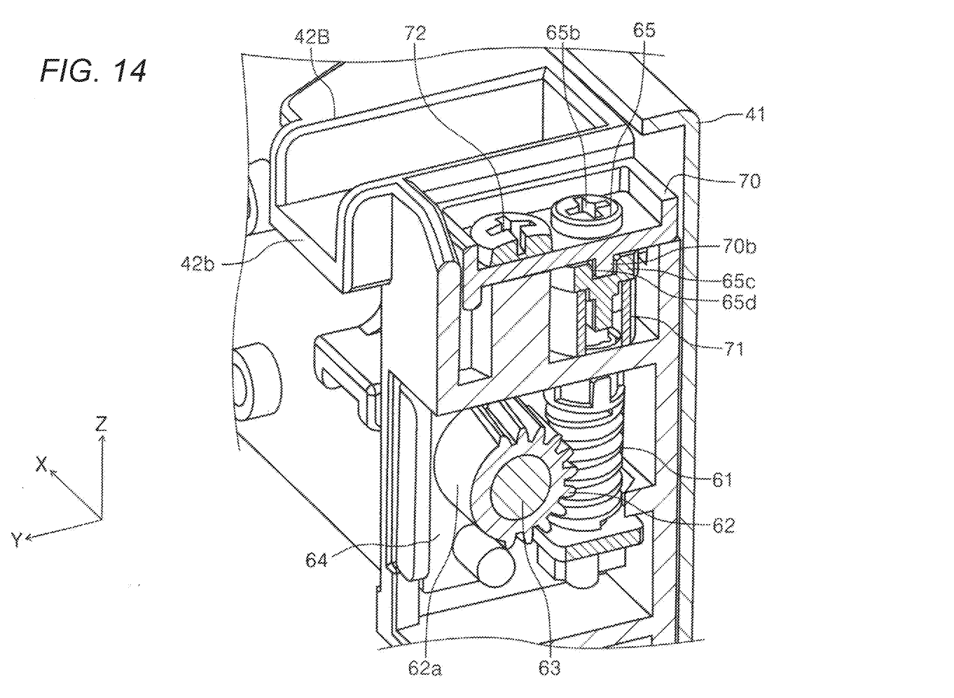

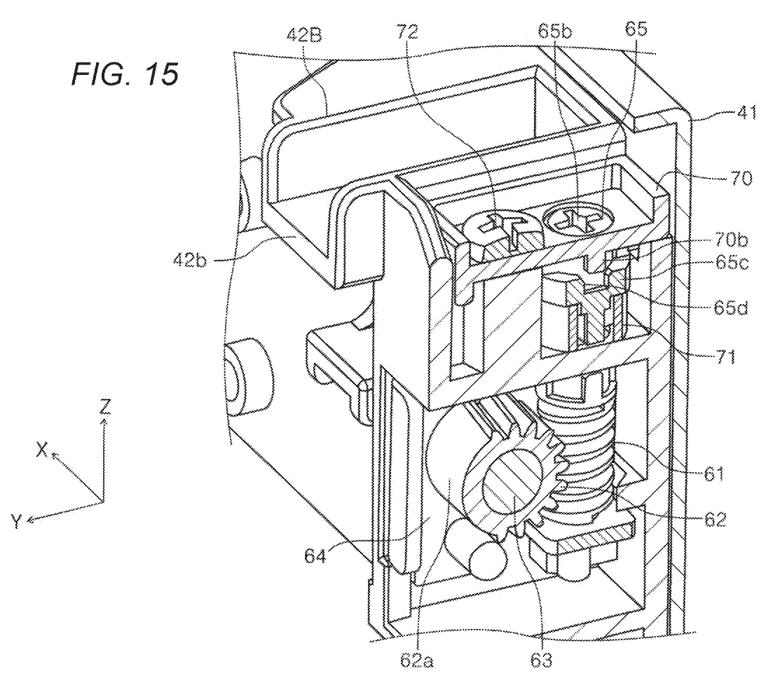

A rotation restricting member 70 engages with the adjustment dial 65, as shown in FIGS. 14 and 15. The rotation restricting member 70 is fixed to the rack member 42B with a screw 72.

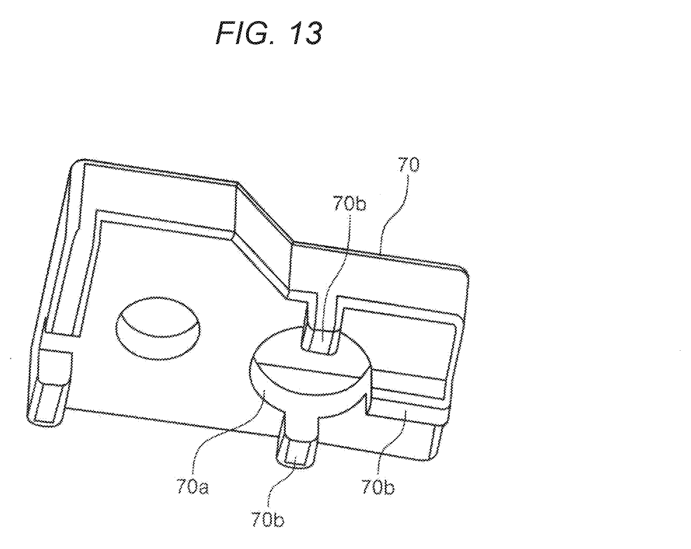

The rotation restricting member 70 has a hole 70a, as shown in FIG. 13,. The cylindrical portion 65a of the adjustment dial 65 is exposed in the +Z direction via the hole 70a.

The lower side of the rotation restricting member 70 forms protrusions 70b. Multiple protrusions 70b are provided at angular intervals of 90° along the direction in which the adjustment dial 65 is rotated. Note, however, that the arrangement of the protrusions 70b is an example and is not necessarily employed, and only one protrusion 70b may be provided.

The adjustment dial 65 has restricted portions 65c, as shown in FIG. 12. The restricted portions 65c are each a portion larger in diameter than the cylindrical portion 65a, and multiple recesses 65d are formed along the circumferential direction of the adjustment dial 65. The protrusions 70b formed at the rotation restricting member 70 can be fitted into the recesses 65d. All the protrusions 70b can be simultaneously fitted into the recesses 65d corresponding thereto.

In FIGS. 14 and 15, the adjustment dial 65 is provided in a displaceable manner in the Z-axis direction, and is pressed in the +Z direction by a coil spring 71, which is an example of a pressing member. The configuration described above can maintain a state in which the protrusions 70b of the rotation restricting member 70 are fitted into the recesses 65d of the adjustment dial 65. In the state in which the protrusions 70b of the rotation restricting member 70 are fitted in the recesses 65d of the adjustment dial 65 as shown in FIG. 14, the adjustment dial 65 cannot rotate, so that the inclination of the recording unit 40 is maintained. The position of the adjustment dial 65 in the state described above is a restriction imposed position where the rotation of the adjustment dial 65 is restricted by the rotation restricting member 70.

To rotate the adjustment dial 65, the adjustment dial 65 is pushed in the −Z direction with the tip of a screwdriver. The rotation unlocks the fitting of the protrusions 70b of the rotation restricting member 70 into the recesses 65d of the adjustment dial 65, so that the adjustment dial 65 can be rotated, as shown in FIG. 15. The position of the adjustment dial 65 in FIG. 15 is a restriction unlocked position where the restriction imposed by the rotation restricting member 70 on the rotation of the adjustment dial 65 is unlocked.

Effects and advantages of the printer 1 having the configuration described above will be described below.

The guide frame 50 includes the first guiding portion 50a and the second guiding portion 50b, which guide the recording unit 40 along the Z-axis. The recording unit 40 includes the first guided portions 53A guided by the first guiding portion 50a and the second guided portion 53B guided by the second guiding portion 50b.

The second guided portion 53B also serves as the rotation mechanism 57, which rotates the recording unit 40 with the first guiding portion 50a as a fulcrum when viewed along the Z-axis. A portion of the mechanism that makes the recording unit 40 movable in the direction in which the platen gap is adjusted is therefore used as a mechanism that adjusts the posture of the recording unit 40, so that an increase in cost and size of the apparatus can be suppressed.

The second guided portion 53B, specifically, the slider 54 and the eccentric cam 56 are configured to sandwich the second guiding portion 50b in the Y-axis direction, that is, the medium conveyance direction. Rotation of the eccentric cam 56 then rotates the recording unit 40 when viewed along the Z-axis. The rotation mechanism 57 can therefore be achieved with a simple configuration.

The rotation mechanism 57 includes the eccentric cam 56, the worm wheel 62 integrated with the eccentric cam 56, and the worm 61, which along with the worm wheel 62 constitutes the worm gear mechanism 60. A large reduction ratio can therefore be provided by the worm gear mechanism 60 to suppress the amount of rotation of the eccentric cam 56 in response to rotation of the worm 61, so that the posture of the recording unit 40 can be appropriately adjusted.

The self-lock function of the worm gear mechanism 60 is less likely to fluctuate the posture of the recording unit 40, so that an appropriate posture of the recording unit 40 can be maintained.

The rotation mechanism 57 includes the adjustment dial 65, which engages with the worm 61, and is configured to rotate the worm 61 by rotating the adjustment dial 65. The worm 61 can thus be readily rotated.

The adjustment dial 65 has the screwdriver fitting hole 65b having a screwdriver fitting shape. The adjustment dial 65, that is, the worm 61 can thus be more readily rotated. Furthermore, even when the adjustment dial 65 is reduced in size, the adjustment dial 65 can be readily rotated, so that the size of the apparatus can be reduced. Since the adjustment dial 65 can be readily rotated even when the adjustment dial 65 is disposed at a place where the user's fingers cannot reach the adjustment dial 65, the adjustment dial 65 can be disposed with improved flexibility.

The rotation mechanism 57 includes the rotation restricting member 70, which restricts the rotation of the worm 61, and the coil spring 71, which serves as a pressing member that presses the adjustment dial 65 against the rotation restricting member 70. The adjustment dial 65 is displaceable to the restriction imposed position (FIG. 14), where rotation thereof is restricted by the rotation restricting member 70, and the restriction unlocked position (FIG. 15), where the restriction is unlocked. When the adjustment dial 65 at the restriction imposed position is pushed in with a screwdriver against the pressing force of the coil spring 71, the adjustment dial 65 is displaced from the restriction imposed position to the restriction unlocked position. As described above, the adjustment dial 65 can be rotated at the restriction unlocked position, and the recording unit 40 can in turn be rotated.

At the restriction imposed position, since the rotation of the adjustment dial 65 is restricted and the rotation of the worm 61 is in turn restricted, fluctuation in the posture of the recording unit 40 can be suppressed, so that an appropriate posture of the recording unit 40 can be maintained.

The printer 1 includes, as an element in an upper portion of the apparatus, the discharge tray 29, which receives a recorded, discharged medium. The discharge tray 29 is openable and closable, and the adjustment dial 65 is exposed when the discharge tray 29 is opened. The adjustment dial 65 can thus be readily accessed, and as a result, the recording unit 40 can be readily rotated.

The worm wheel 62 has a toothless portion 62a, as shown in FIGS. 14 and 15. The toothless portion 62a restricts the range over which the worm wheel 62 rotates. The toothless portion 62a therefore prevents the recording unit 40 from rotating by an amount greater than expected, so that breakage or any other problem can be suppressed.

The eccentric cam 56 has a mark 56a, as shown in FIG. 12. In the front view of the eccentric cam 56 viewed in the −X direction, when the mark 56a is located at a 3-o'clock position of a timepiece as shown in FIG. 12, it indicates that the recording unit 40 is present at the middle position of the rotatable range thereof. The mark 56a allows the user to visually grasp the posture of the recording unit 40. Note in the present embodiment that the rotatable range of the eccentric cam 56 is smaller than 360°.

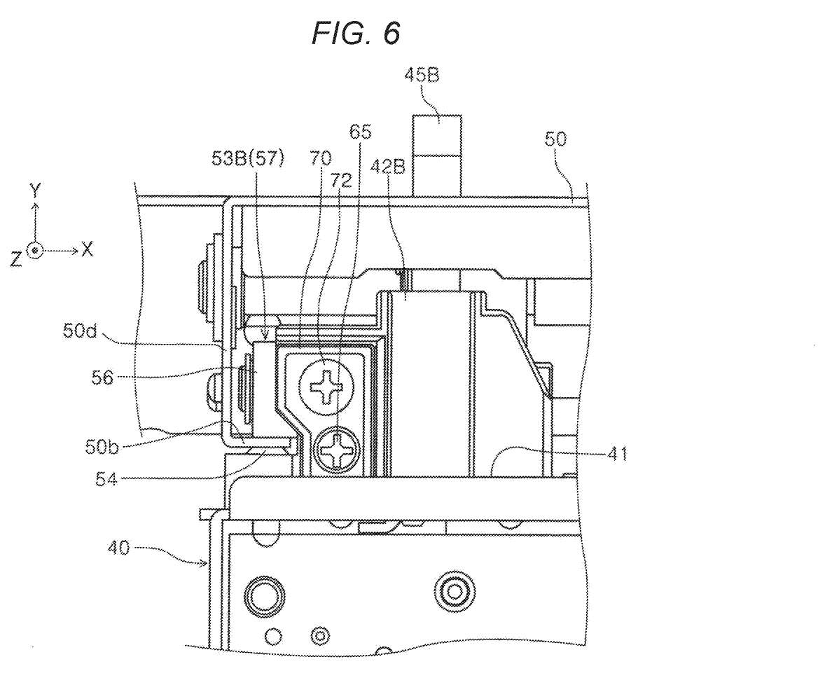

Note that a portion of the eccentric cam 56 is exposed when viewed in the +Z direction, as shown in FIG. 6. It is therefore also preferable to provide the mark 56a at a position visible when viewed in the +Z direction.

Two first guided portions 53A are provided so as to be separate from each other along the Z-axis, and are each configured to sandwich the first guiding portion 50a in the medium conveyance direction, and one second guided portion 53B is provided. The posture of the guide frame 50 is thus stabilized when the recording unit 40 moves along the Z-axis.

A frame structure 80, which constitutes the base of the apparatus body 1a, will subsequently be described.

The base of the apparatus body 1a is configured with the frame structure 80 shown in FIG. 17. That is, the apparatus body 1a is configured with the frame structure 80 to which multiple constituent members are attached. Exterior members made of resin are provided at the exterior of the frame structure 80.

The frame structure 80 includes a first side plate 81, a second side plate 82, a first linkage member 83, a second linkage member 84, and a cover member 85, as shown in FIGS. 17 and 18. In the present embodiment, the members that constitute the frame structure 80 are each configured with a metal plate.

The first side plate 81 and the second side plate 82 have surfaces parallel to the Y-Z plane, that is, surfaces that intersect with the X-axis direction, and are disposed so as to be separate from each other in the X-axis direction. The first side plate 81 supports the +X-side end of the guide frame 50, and the second side plate 82 supports the −X-side end of the guide frame 50. That is, the first side plate 81 and the second side plate 82 support the recording unit 40 via the guide frame 50. Note that the guide frame 50 is fixed to the first side plate 81 and the second side plate 82 with screws that are not shown.

The first side plate 81 supports the +X-side end of the shutter 32a, and the second side plate 82 supports the −X-side end of the shutter 32a. The shutter 32a is guided in a movable manner in the Y-axis direction with the posture thereof restricted by the first side plate 81 and the second side plate 82.

Furthermore, the first side plate 81 supports the +X-side end of the driving roller 16, and the second side plate 82 supports the −X-side end of the driving roller 16.

The first linkage member 83 is a member extending in the X-axis direction, and links the bottom of the first side plate 81 to the bottom of the second side plate 82. The second linkage member 84 is a member extending in the X-axis direction, is disposed so as to be separate from the first linkage member 83 in the Y-axis direction, and links the bottom of the first side plate 81 to the bottom of the second side plate 82. The first linkage member 83 and the second linkage member 84 are fixed, for example, to the first side plate 81 and the second side plate 82 with screws.

The cover member 85 is provided to close a bottom opening of the structure formed by the first side plate 81, the second side plate 82, the first linkage member 83, and the second linkage member 84. The cover member 85 is fixed to the bottoms of the first side plate 81 and the second side plate 82 with screws.

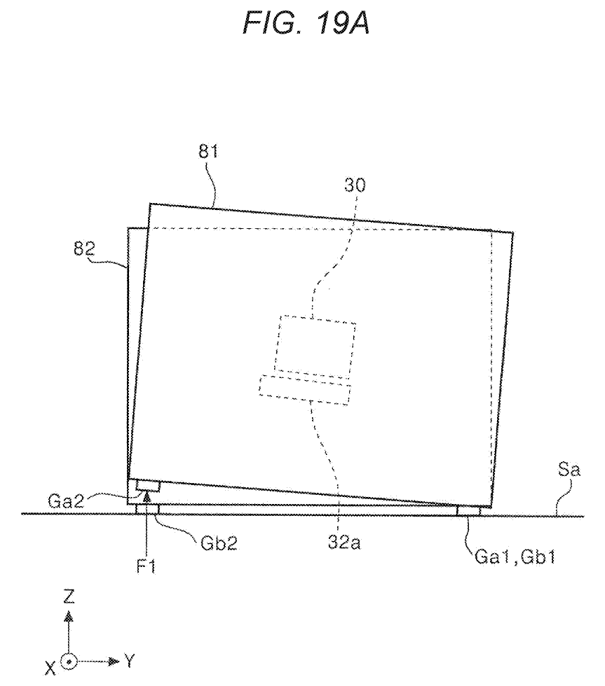

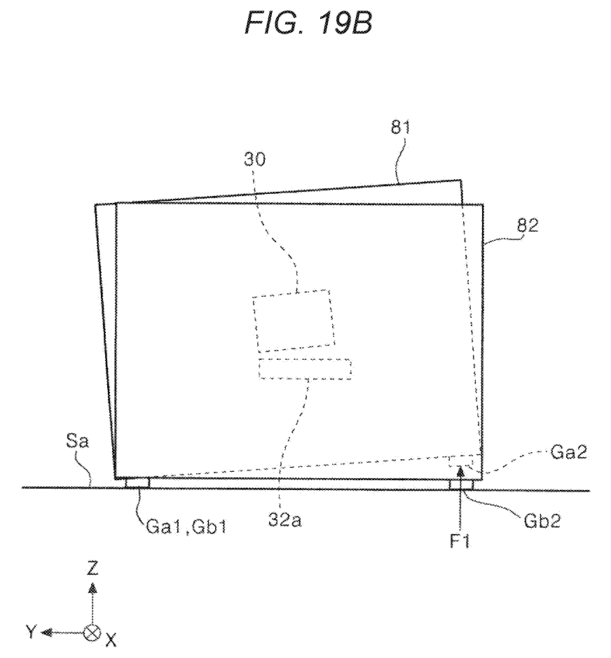

A problem with a case where legs are provided at the bottoms of the first side plate 81 and the second side plate 82 will now be described with reference to FIGS. 19A and 19B. FIG. 19A shows the postures of the line head 30 and the shutter 32a in the vicinity of the first side plate 81 with broken lines, and FIG. 19B shows the postures of the line head 30 and the shutter 32a in the vicinity of the second side plate 82 with broken lines.

In FIGS. 19A and 19B, legs Ga1 and Ga2 are provided at the bottom of the first side plate 81, and legs Gb1 and Gb2 are provided at the bottom of the second side plate 82. The leg Ga1 is provided at a +Y-side end portion of the bottom of the first side plate 81, and the leg Ga2 is provided at a −Y-side end portion of the bottom of the first side plate 81. The leg Gb1 is provided at a +Y-side end portion of the bottom of the second side plate 82, and the leg Gb2 is provided at a −Y-side end portion of the bottom of the second side plate 82. That is, in FIGS. 19A and 19B, the legs are provided at the four corners of the bottom surface of the frame structure 80. Reference character Sa represents an installation surface at which the printer 1 is installed.

In the configuration described above, for example, consider a case where the installation surface Sa is not flat and a push-up force F1 is applied to the leg Ga2. In this case, as an example, the first side plate 81 rotates with the leg Ga1 as a fulcrum, that is, the first side plate 81 and the second side plate 82 rotate relative to each other.

In the recording unit 40 (line head 30), the +X-side end portions of the two first guided portions 53A provided so as to be separate from each other in the Z-axis direction are guided in the Z-axis direction by the first guiding portion 50a, as described with reference to FIG. 10.

In the recording unit 40 (line head 30), the −X-side end portion of the one second guided portion 53B provided in the Z-axis direction is guided in the Z-axis direction by the second guiding portion 50b, as described with reference to FIG. 11.

The inclination of the first guiding portion 50a in response to the rotation of the first side plate 81 is therefore followed by inclination of the line head 30, as shown in FIG. 19A. Since only one second guided portion 53B is provided for the second guiding portion 50b, the line head 30 is not likely to be restricted by the rotation of the second guiding portion 50b in the vicinity of the second side plate 82. The inclination of the first guiding portion 50a is therefore followed by inclination of the line head 30 also in the vicinity of the second side plate 82, as shown in FIG. 19B.

The shutter 32a is, however, supported with the posture thereof restricted by the first side plate 81 and the second side plate 82. Therefore, when the first side plate 81 is deformed or rotated, the shutter 32a inclines in the vicinity of the first side plate 81 as shown in FIG. 19A, but does not incline in the vicinity of the second side plate 82 because the shutter 32a is restricted by the second side plate 82 as shown in FIG. 19B.

As described above, in the configuration in which the multiple first guided portions 53A are provided for the first guiding portion 50a and one second guided portion 53B is provided for the second guiding portion 50b, the line head 30 and the shutter 32a incline in the same manner in the vicinity of the first side plate 81 (FIG. 19A), but since only the line head 30 inclines in the vicinity of the second side plate 82 (FIG. 19B), the line head 30 inclines with respect to the shutter 32a in the vicinity of the second side plate 82, so that there is a concern that the recording quality deteriorates.

Note that the above description has been made on the assumption that the first side plate 81 rotates when the push-up force F1 is applied to the leg Ga2, and the same problem may occur when the first side plate 81 is deformed when the push-up force F1 is applied to the leg Ga2.

To avoid the problem described above, the leg portions are arranged as described below in the present embodiment.

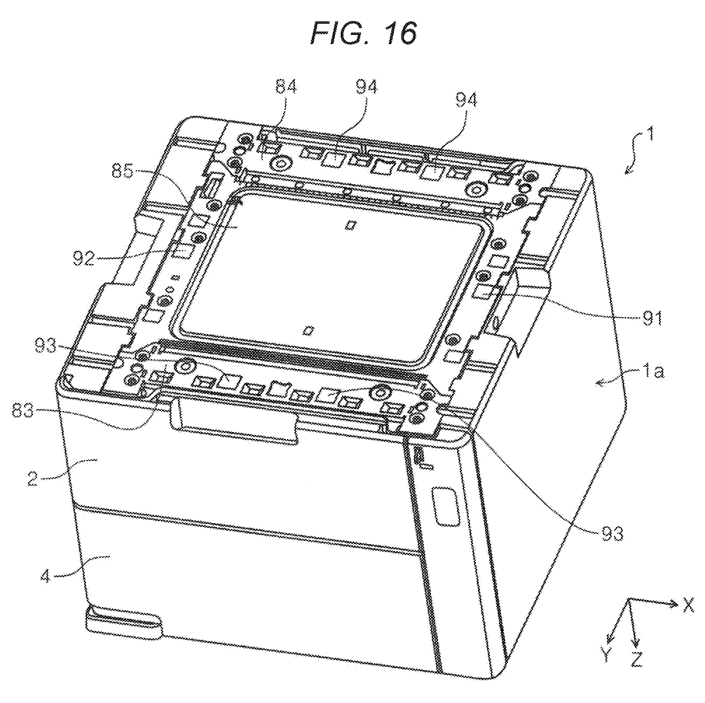

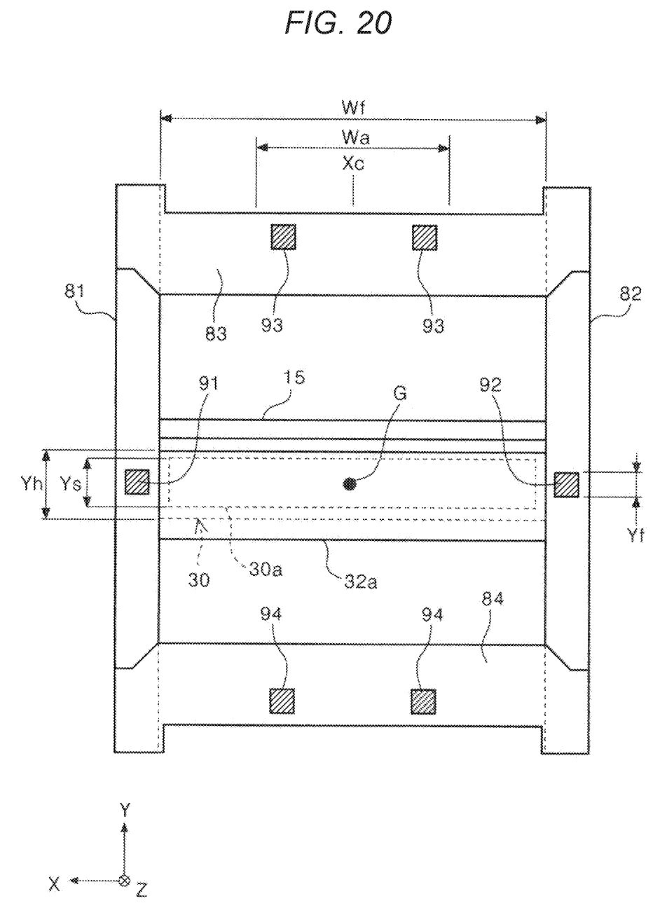

The first side plate 81 is provided with a first leg 91, as shown in FIGS. 16 and 20. The second side plate 82 is provided with a second leg 92. The first leg 91 is a member in contact with the apparatus installation surface Sa, and constitutes a first support that supports the first side plate 81. The second leg 92 is a member in contact with the apparatus installation surface Sa, and constitutes a second support that supports the second side plate 82.

Note that FIG. 20 does not show the cover member 85 described with reference to FIGS. 17 and 18. In the present embodiment, the cover member 85 is interposed between the first leg 91 and the first side plate 81, and the first leg 91 may instead be directly attached to the first side plate 81. Similarly, in the present embodiment, the cover member 85 is interposed between the second leg 92 and the second side plate 82, and the second leg 92 may instead be directly attached to the second side plate 82.

The first linkage member 83 is provided with third legs 93. The second linkage member 84 is provided with fourth legs 94. The third legs 93 are members in contact with the apparatus installation surface Sa, and constitute a third support that supports the first linkage member 83. The fourth legs 94 are members in contact with the apparatus installation surface Sa, and constitute a fourth support that supports the second linkage member 84.

Each of the first leg 91, the second leg 92, the third legs 93, and the fourth legs 94 may be made of an elastic material such as rubber, and may be glued to the bottom of the corresponding member with a double-sided tape, an adhesive, or the like, or may be mechanically fixed with a screw or the like.

Note that the legs shown in FIG. 20 are hatched for convenience of illustration.

In FIG. 20, reference character Yh represents the region occupied by the line head 30 in the Y-axis direction, and reference character Ys represents the region occupied by the head surface 30a in the Y-axis direction. In FIG. 20, reference character G represents the position of the center of gravity of the printer 1.

The first leg 91 is provided for the first side plate 81 at one location in the occupied region Yh, and the second leg 92 is provided for the second side plate 82 at one location in the occupied region Yh, as shown in FIG. 20.

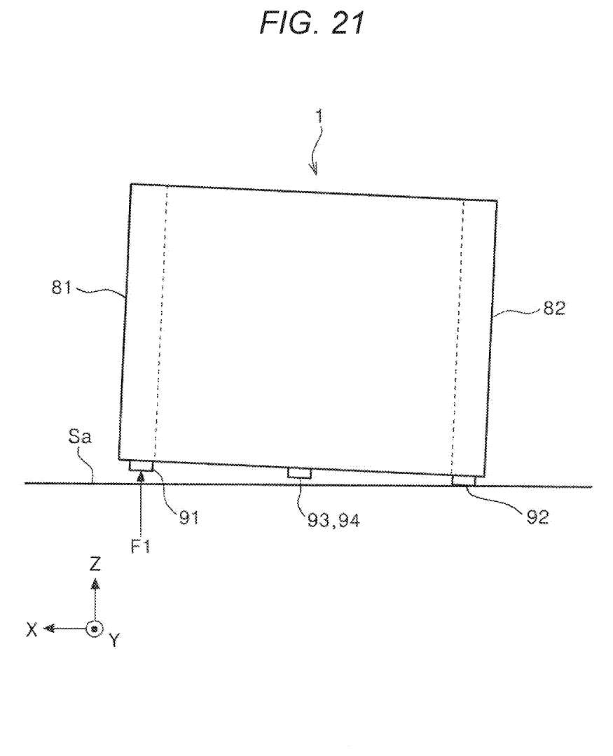

Therefore, for example, when the first leg 91 receives a push-up force from the apparatus installation surface Sa, the force is unlikely to cause deformation or rotation of the first side plate 81 but is likely to cause inclination of the entire apparatus with the second leg 92, which is provided for the second side plate 82, as a fulcrum. FIG. 21 diagrammatically shows the inclination described above, and when the first leg 91 receives the push-up force F1 from the apparatus installation surface Sa, the entire apparatus inclines with the Y-axis as the center of rotation, as shown in FIG. 21. Also, when the second leg 92 receives a push-up force from the apparatus installation surface Sa, the force does not cause deformation or rotation of the second side plate 82 but causes inclination of the entire apparatus. That is, according to the present embodiment, deformation and rotation of the first side plate 81 or the second side plate 82 can be suppressed, and deterioration in recording quality can in turn be suppressed.

In the present embodiment, the first leg 91 is provided for the first side plate 81 at one location in the region Yh occupied by the line head 30 in the Y-axis direction, and the second leg 92 is provided for the second side plate 82 at one location in the region Yh occupied by the line head 30 in the Y-axis direction, as shown in FIG. 20. Therefore, even if the first side plate 81 or the second side plate 82 is deformed or rotated to some extent, the influence of the deformation or rotation is small at the position of the line head 30, so that the deterioration in the recording quality can be suppressed.

Note in the present embodiment that the first leg 91 and the second leg 92 are off the region occupied by the line head 30 in the X-axis direction, and may instead be disposed in the region occupied by the line head 30 in the X-axis direction.

Note that the first leg 91 constitutes the first support, which is in contact with the apparatus installation surface Sa and supports the first side plate 81, but that the first support only needs to be provided at one location in the region Yh occupied by the line head 30 in the Y-axis direction, and that the present aspect does not necessarily employ only one first leg 91. For example, multiple first legs 91 may constitute the first support. In this case, it is preferable that two adjacent first legs 91 are separate from each other in the Y-axis direction by a small distance. In this case, the upper limit of the distance described above can be set as appropriate at a value within a range over which the problem described with reference to FIGS. 19A and 19B can be suppressed when the first support receives the push-up force from the apparatus installation surface Sa.

The second leg 92 similarly constitutes the second support, which is in contact with the apparatus installation surface Sa and supports the second side plate 82, but that the second support only needs to be provided at one location in the region Yh occupied by the line head 30 in the Y-axis direction, and that the present aspect does not necessarily employ only one second leg 92.

Note, however, that since the first support and the second support are each configured with one leg, deformation of the first side plate 81 and the second side plate 82 can be suppressed as compared with a case where the first support and the second support are each configured with multiple legs.

In the present embodiment, the first leg 91, that is, the first support is provided for the first side plate 81 at one location in the region Ys occupied by the head surface 30a in the Y-axis direction, and the second leg 92, that is, the second support is provided for the second side plate 82 at one location in the region Ys occupied by the head surface 30a in the Y-axis direction.

Therefore, even if the first side plate 81 or the second side plate 82 is deformed or rotated to some extent, the influence of the deformation or rotation is small at the position of the head surface 30a, so that the deterioration in the recording quality can be effectively suppressed.

In the present embodiment, the position of the center of gravity G of the apparatus overlaps the line head 30 in the bottom view of the apparatus. Accordingly, the first leg 91 is close to the position of the center of gravity G in the Y-axis direction, so that deformation of the first side plate 81 is suppressed. Similarly, the second leg 92 is close to the position of the center of gravity G in the Y-axis direction, so that deformation of the second side plate 82 is suppressed. The deterioration in the recording quality can thus be further suppressed.

In the present embodiment, the position of the center of gravity G is within a region Yf occupied by the first leg 91 and the second leg 92 in the Y-axis direction. The occupied region Yf is a region occupied by the first leg 91 and the second leg 92 in the Y-axis direction.

In the present embodiment, one first leg 91 and one second leg 92 are provided, and the positions thereof in the Y-axis direction coincide with each other, but when multiple first legs 91 or second legs 92 are provided, or when the positions of the first leg 91 and the second leg 92 in the Y-axis direction are shifted from each other, the occupied region Yf is wider than the region shown in FIG. 20.

As described above, since the position of the center of gravity G is within the occupied region Yf in the Y-axis direction, the posture of the apparatus is likely to be stabilized in the Y-axis direction, and the deformation of the first side plate 81 and the second side plate 82 is suppressed, so that the deterioration in the recording quality can be suppressed.

In the present embodiment, the third legs 93, that is, the third support and the fourth legs 94, that is, the fourth support are separate from the first side plate 81 and the second side plate 82 by at least 1/4 of the distance between the first side plate 81 and the second side plate 82 in the X-axis direction. In FIG. 20, reference character Wf represents the distance between the first side plate 81 and the second side plate 82, and reference character Wa represents a region separate from the first side plate 81 and the second side plate 82 by at least 1/4 of the distance Wf. The third legs 93, that is, the third support and the fourth legs 94, that is, the fourth support are disposed in the region Wa.

Therefore, when the third legs 93 or the fourth legs 94 receive a push-up force from the apparatus installation surface Sa, the influence of the push-up force on the deformation of the first side plate 81 or the second side plate 82 can be reduced, so that the deterioration in the recording quality can be suppressed.

Note in the present embodiment that the third legs 93 and the fourth legs 94 are provided at the same position in the X-axis direction, and may instead be provided at different positions in the X-axis direction. Furthermore, in the present embodiment, in which two third legs 93 and two fourth legs 94 are provided, one or three or more third legs 93 and one or three or more fourth legs 94 may be provided, or the number of third legs 93 and the number of fourth legs 94 may differ from each other.

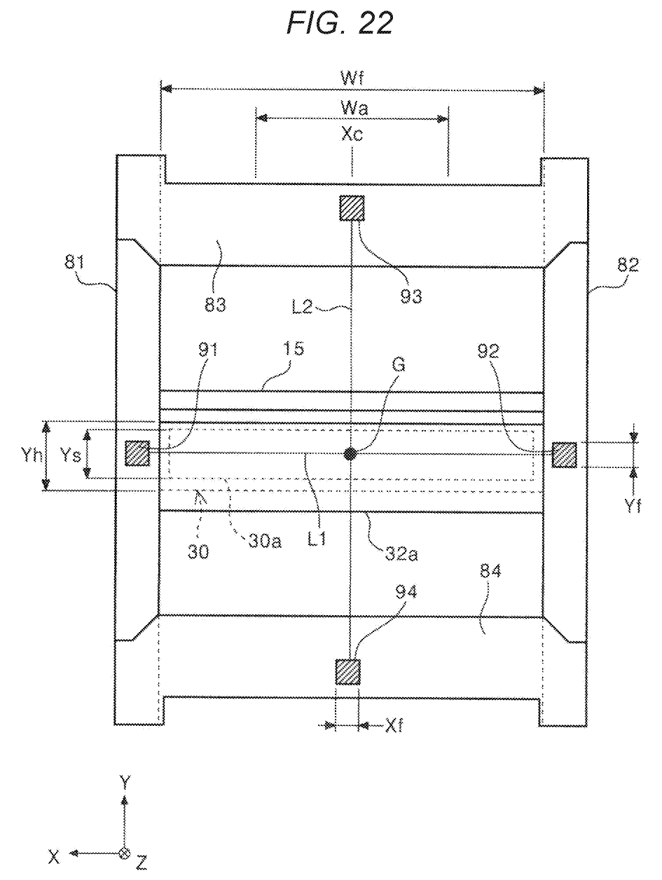

Note that the third support and the fourth support may be provided at a middle position Xc between the first side plate 81 and the second side plate 82 in the X-axis direction, as in a variation shown in FIG. 22. In this case, it is particularly preferable that one third leg 93, which constitutes the third support, and one fourth leg 94, which constitutes the fourth support, are provided at the middle position Xc. Therefore, when the third leg 93 or the fourth leg 94 receives a push-up force from the apparatus installation surface Sa, the influence of the push-up force on the deformation of the first side plate 81 or the second side plate 82 can be effectively reduced, so that the deterioration in the recording quality can be suppressed.

In this case, the position of the center of gravity G may be inside a region Xf occupied by the third leg 93 and the fourth leg 94 in the X-axis direction. Accordingly, the posture of the apparatus is likely to be stabilized in the X-axis direction, and deformation of the first linkage member 83 and the second linkage member 84 is suppressed, so that the deterioration in the recording quality can be suppressed.

In FIG. 22, a straight line L1 is a straight line that couples the first leg 91 to the second leg 92, and a straight line L2 is a straight line that couples the third leg 93 to the fourth leg 94. In the present embodiment, the straight line L1 and the straight line L2 are perpendicular to each other. Furthermore, in the present embodiment, the position of the center of gravity G is at the position where the straight line L1 and the straight line L2 intersect with each other. According to the configuration described above, the deformation and rotation of the first side plate 81 and the second side plate 82 can be preferably suppressed.

In a configuration in which the position of the center of gravity G of the apparatus moves as an optional apparatus is attached to or detached from the printer 1 or a movable portion of the printer 1 moves, it is also preferable that the position of the center of gravity G in the bottom view of the apparatus is located within a region the vertices of which coincide with the first leg 91, the second leg 92, the third leg 93, and the fourth leg 94 before and after the movement.

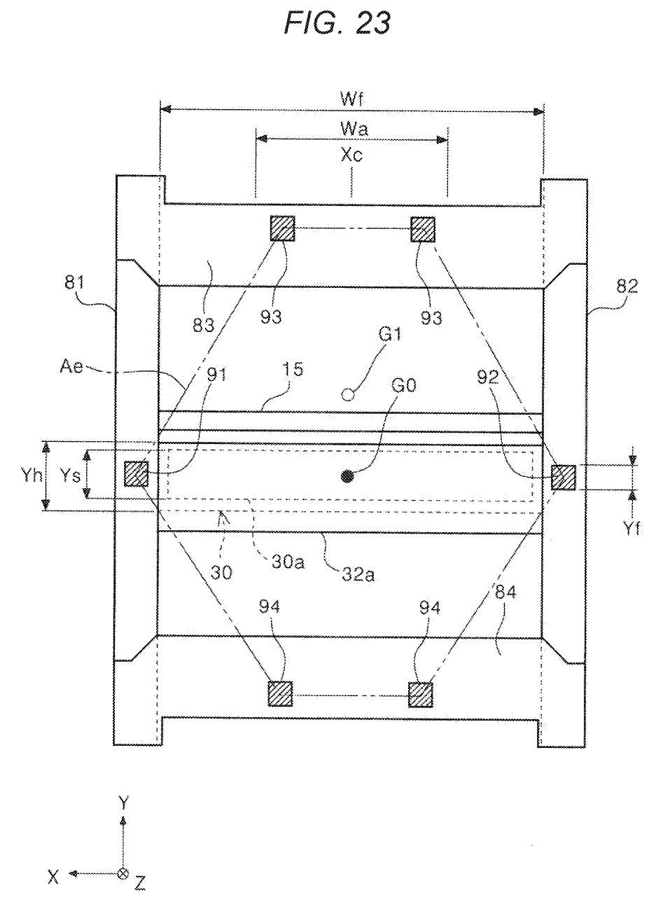

A region indicated by reference character Ae in FIG. 23 is the region the vertices of which coincide with the first leg 91, the second leg 92, the third legs 93, and the fourth legs 94.

Reference character G0 represents the position of the center of gravity before the movement, and reference character G1 represents the position of the center of gravity after the movement. For example, the position of the center of gravity G0 is the position of the center of gravity in a state in which the medium storage cassette 2 is attached (see FIGS. 1 and 2), and the position of the center of gravity G1 is the position of the center of gravity in a state in which the medium storage cassette 2 is pulled out in the +Y direction. Note that the position of the center of gravity of the apparatus is also moved along the Y-axis direction by opening and closing the openable/closeable member 4 shown in FIG. 1. Specifically, the position of the center of gravity of the apparatus is the position indicated by reference character G0 in a state in which the openable/closeable member 4 is closed, and the position of the center of gravity of the apparatus is the position indicated by reference character G1 in a state in which the openable/closeable member 4 is opened. The medium storage cassette 2 and the openable/closeable member 4 are examples of the movable portion of the printer 1. In addition, when an optional apparatus, such as an additional cassette, is attached to or detached from the printer 1, the position of the center of gravity of the apparatus moves.

In the configuration in which the position of the center of gravity of the apparatus moves as the movable portion moves or the optional apparatus is attached or detached, when the position of the center of gravity of the apparatus is off the region the vertices of which coincide with the first leg 91, the second leg 92, the third legs 93, and the fourth legs 94, the posture of the apparatus is likely to be unstable.

However, the present embodiment, in which the position of the center of gravity of the apparatus in the bottom view of the apparatus is located within the region Ae, the vertices of which coincide with the first leg 91, the second leg 92, the third legs 93, and the fourth legs 94 before and after the movement, can prevent the posture of the apparatus from becoming unstable due to the movement of the position of the center of gravity of the apparatus.

The present disclosure is not limited to the embodiment and the variations thereof described above, various changes can be made thereto within the scope of the disclosure described in the claims, and it is needless to say that the variations also fall within the scope of the disclosure.

What is claimed is:

1. A recording apparatus comprising:
a recorder configured to perform recording on a medium;
a first side plate having a surface intersecting with a first axis direction and configured to support the recorder;
a second side plate having a surface intersecting with the first axis direction, disposed so as to be separate from the first side plate in the first axis direction, and configured to support the recorder;
a first linkage member extending in the first axis direction and configured to couple a bottom of the first side plate to a bottom of the second side plate;
a second linkage member extending in the first axis direction, disposed so as to be separate from the first linkage member in a second axis direction intersecting with the first axis direction, and configured to link the bottom of the first side plate to the bottom of the second side plate;
a first support that is a member being in contact with an installation surface at which the apparatus is installed and configured to support the first side plate;
a second support that is a member being in contact with the installation surface and configured to support the second side plate;
a third support that is a member being in contact with the installation surface and configured to support the first linkage member; and
a fourth support that is a member being in contact with the installation surface and configured to support the second linkage member,
wherein the first support is provided for the first side plate at one location in a region occupied by the recorder in the second axis direction, and
the second support is provided for the second side plate at one location in the region occupied by the recorder in the second axis direction.

2. The recording apparatus according to claim 1, wherein
the recorder includes an ink ejecting head configured to eject ink in a direction having a vertically downward component,
the first support is provided for the first side plate at one location in a region occupied by a head surface of the ink ejecting head in the second axis direction, and
the second support is provided for the second side plate at one location in the region occupied by the head surface in the second axis direction.

3. The recording apparatus according to claim 1, wherein
a position of a center of gravity of the apparatus overlaps with the recorder in a bottom view of the apparatus.

4. The recording apparatus according to claim 3, wherein
the position of the center of gravity is within a region occupied by the first support and the second support in the second axis direction.

5. The recording apparatus according to claim 3, wherein
the third support and the fourth support are separate from the first side plate and the second side plate by at least 1/4 of a distance between the first side plate and the second side plate in the first axis direction.

6. The recording apparatus according to claim 5, wherein
the third support and the fourth support are provided at a middle position between the first side plate and the second side plate in the first axis direction.

7. The recording apparatus according to claim 6, wherein
the position of the center of gravity is within a region occupied by the third support and the fourth support in the first axis direction.

8. The recording apparatus according to claim 1, wherein
the first support and the second support are each configured with one leg.

9. The recording apparatus according to claim 1, wherein
a position of a center of gravity of the apparatus moves as an optional apparatus is attached to and detached from the recording apparatus or as a movable portion in the recording apparatus moves, and
the position of the center of gravity in a bottom view of the apparatus is located within a region vertices of which coincide with the first support, the second support, the third support, and the fourth support before and after the movement.

10. The recording apparatus according to claim 1, further comprising:
a facing portion that is a member facing the recorder, extending along the first axis direction, and supported by the first side plate and the second side plate; and
a guide frame configured to guide a recording unit including the recorder along a third axis direction being a direction in which a distance between the recorder and the facing portion changes, the guide frame fixed to the first side plate and the second side plate,
wherein the guide frame includes
a first guiding portion configured to guide the recording unit along the third axis direction, and
a second guiding portion located at a position separate from the first guiding portion in the first axis direction and configured to guide the recording unit along the third axis direction,
the recording unit includes
a first guided portion guided by the first guiding portion, and
a second guided portion guided by the second guiding portion,
the first guided portion is configured with multiple first guided portions provided in the third axis direction, and
the second guided portion is configured with one second guided portion provided in the third axis direction.

11. The recording apparatus according to claim 10, wherein
the second guided portion also serves as a rotation mechanism configured to rotate the recording unit with the first guiding portion as a fulcrum when viewed in the third axis direction.
